(19) United States
(12) Patent Application Publication
(10) Pub. No.: US 2006/0260480 A1
(43) Pub. Date: Nov. 23, 2006

(54) Liquid supply apparatus

(75) Inventor: Hiroyuki Sugiyama, Tokyo (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 11/411,099

(22) Filed: Apr. 26, 2006

(30) Foreign Application Priority Data
Apr. 27, 2005 (JP) 2005-128887

(51) Int. Cl. B41L 13/00

(52) U.S. Cl. 101/119

(57) ABSTRACT

In a screen printing unit including a rotary screen device, the rotary screen device has rotatably supported flanges, and a cylindrical screen supported by the flanges so as to be connected to an impression cylinder and provided with small holes on a peripheral surface thereof and a squeegee disposed inside the screen to abut on an inner peripheral surface of the screen and configured to supply special ink stored inside the screen from the small holes on the screen toward the impression cylinder. The rotary screen device includes a guard configured to be positioned between a gap of the impression cylinder and the screen when opposed to the gap and to movably support the squeegee through the screen.

### BACKGROUND OF THE INVENTION

1. Field of the Invention

The present invention relates to a liquid supply apparatus configured to supply a liquid such as ink or varnish from holes on a plate material such as a screen to a sheet such as a flat paper sheet retained on an impression cylinder by use of a squeegee and thereby to perform printing or coating. More specifically, the present invention is suitable for application to a screen printing unit of a printing press configured to perform screen printing on a flat paper sheet.

2. Description of the Related Art

A rotary screen device which includes a thin cylindrical screen provided with holes etched in accordance with an image and rotatably supported by a hollow cylinder, and a squeegee located inside the screen, is used in a conventional way of performing screen printing. Here, a liquid such as ink or varnish stored inside the screen is pushed out of the holes on the screen by use of the squeegee. In this way, it is possible to perform printing on a flat paper sheet, which represents a sheet retained on an impression cylinder, in accordance with the image. Accordingly, the rotary screen device is able to put special ink or the like thickly onto the flat paper sheet, and is therefore applied to the case where an upscale taste in terms appearance, texture, or the like is expected.

When printing on the flat paper sheet by use of the above-mentioned rotary screen device, if a gripper for retaining the flat paper sheet provided on the impression cylinder facing the screen projects from an outer peripheral surface thereof, the gripper may contact and thereby damage the screen.

In this regard, the following Patent Document 1, for instance, discloses a technique configured to locate a gripper and a gripper pad inside a gap of an impression cylinder so as not to project from an outer peripheral surface of the impression cylinder, to provide a cover capable of opening and closing for covering the gap, and to open and close the cover synchronously with opening and closing operations of the gripper when retaining or releasing a flat paper sheet to enable retention and release of the flat paper sheet, and thereby to prevent damage on a screen attributable to falling of the screen into the gap on the impression cylinder or contact of the screen with the gripper (a projection).

{Patent Document 1}

Japanese Patent Translation Publication No. 2000-504643

However, the technique disclosed in the above-mentioned Patent Document 1 is configured to rotate the impression cylinder while performing opening and closing operations of the cover that entirely covers the gap. Accordingly, the cover may vibrate and deteriorate surface uniformity of the outer periphery when the cover closes the gap in the course of a high-speed operation. Therefore, this technique is hardly applicable to high-speed printing. Moreover, the vibrating cover may contact and damage the screen.

These problems may occur not only when putting the special ink thickly on the flat paper sheet with the squeegee by use of the screen having the small holes in accordance with the image, but also when supplying a liquid from holes of a plate material on a rotary screen device to a sheet retained on an impression cylinder by use of a squeegee, or when coating varnish on a flat paper sheet with a squeegee by use of a screen having small holes on the entire surface thereof, for example.

### SUMMARY OF THE INVENTION

In consideration of the foregoing problems, it is an object of the present invention to provide a liquid supply apparatus capable of supplying a liquid from holes on a plate material on a rotary screen device to a sheet retained on an impression cylinder by use of a squeegee favorably even at a high speed.

To solve the problems, the present invention provides a liquid supply apparatus provided with a rotatably supported impression cylinder having a gap formed on an outer peripheral surface, sheet holding means located inside the gap of the impression cylinder for holding the sheet, a rotary screen device having a rotatably supported hollow cylinder, a cylindrical plate material supported by the hollow cylinder so as to oppose the impression cylinder and provided with a hole on a peripheral surface, and a squeegee located inside the plate material so as to abut on an inner peripheral surface of the plate material and configured to supply a liquid stored inside the plate material from the hole of the plate material toward the impression cylinder. Here, the rotary screen device includes a guide member configured to be positioned between the gap and the plate material when opposed to the gap of the impression cylinder and to movably support the squeegee through the plate material.

Meanwhile, the present invention provides the above-described liquid supply apparatus, in which the guide member is formed into an arc shape including an inner peripheral surface having substantially the same curvature as curvature of the outer peripheral surface of the plate material.

Moreover, the present invention provides the above-described liquid supply apparatus, in which the outer peripheral surface of the impression cylinder and the guide member are formed such that the squeegee is movably supported once by both of the outer peripheral surface of the impression cylinder and the guide member simultaneously.

Meanwhile, the present invention provides the above-described liquid supply apparatus, in which a size of the guide member is set such that a clearance is provided between an end portion of the guide on a downstream side in a rotational direction member and an end portion of the gap on a downstream side in a rotational direction when the end portions oppose each other, and that a clearance is provided between an end portion of the guide on an upstream side in a rotational direction member and an end portion of the gap on an upstream side in a rotational direction when the end portions oppose each other.

Moreover, the present invention provides the above-described liquid supply apparatus, in which the guide member is configured to enter the gap of the impression cylinder without causing interference with the sheet holding means when the guide member opposes the gap.

Meanwhile, the present invention provides the above-described liquid supply apparatus, in which the end portions of the gap of the impression cylinder and the end portions of the guide member are formed such that a size of the clearance in the rotational directions becomes substantially uniform throughout a length in a direction along a width direction of the impression cylinder.

Moreover, the present invention provides the above-described liquid supply apparatus, in which the end portions of the gap of the impression cylinder and the end portions of the guide member are formed such that the clearance is inclined in terms of an axial direction of the impression cylinder.

In addition, the present invention provides the above-described liquid supply apparatus, in which the end portions of the gap of the impression cylinder and the end portions of the guide member are formed such that the clearance meanders in terms of an axial direction of the impression cylinder.

### BRIEF DESCRIPTION OF THE DRAWINGS

The present invention will become more fully understood from the detailed description given hereinbelow and the accompanying drawings which are given by way of illustration only, and thus are not limitative of the present invention and wherein;

FIG. 1 shows an overall schematic block diagram of a printing press including a screen printing unit applying a liquid supply apparatus according to a first embodiment of the present invention;

FIG. 2 shows an extracted and enlarged view of a section indicated with an arrow II in FIG. 1;

FIG. 3 shows an extracted and enlarged view of a section indicated with an arrow III in FIG. 2;

FIG. 4 shows a plan view of an impression cylinder shown in FIG. 2;

FIG. 5 shows a cross-sectional view of a substantial part of a rotary screen device shown in FIG. 2, which is taken along an axial direction;

FIG. 6 shows a cross-sectional view of a substantial part of a rotary screen device of a liquid supply apparatus according to another embodiment of the present invention;

FIG. 7 shows a cross-sectional view of a substantial part of a rotary screen device of a liquid supply apparatus according to still another embodiment of the present invention;

FIG. 8 shows a cross-sectional view of a substantial part of a rotary screen device of a liquid supply apparatus according to yet another embodiment of the present invention;

FIG. 9 shows an extracted and enlarged view of a substantial part of a liquid supply apparatus according to another embodiment of the present invention;

FIG. 10 shows an overall schematic block diagram of a printing press including a screen printing unit applying a liquid supply apparatus according to another embodiment of the present invention;

FIG. 11 shows an overall schematic block diagram of a printing press including a screen printing unit applying a liquid supply apparatus according to still another embodiment of the present invention; and

FIG. 12 shows an overall schematic block diagram of a printing press including a screen printing unit applying a liquid supply apparatus according to yet another embodiment of the present invention.

### DETAILED DESCRIPTION OF THE PRESENT INVENTION

Embodiments of the present invention will now be described with reference to the accompanying drawings. It is to be noted, however, that the present invention will not be limited only to the following embodiments.

### First Embodiment

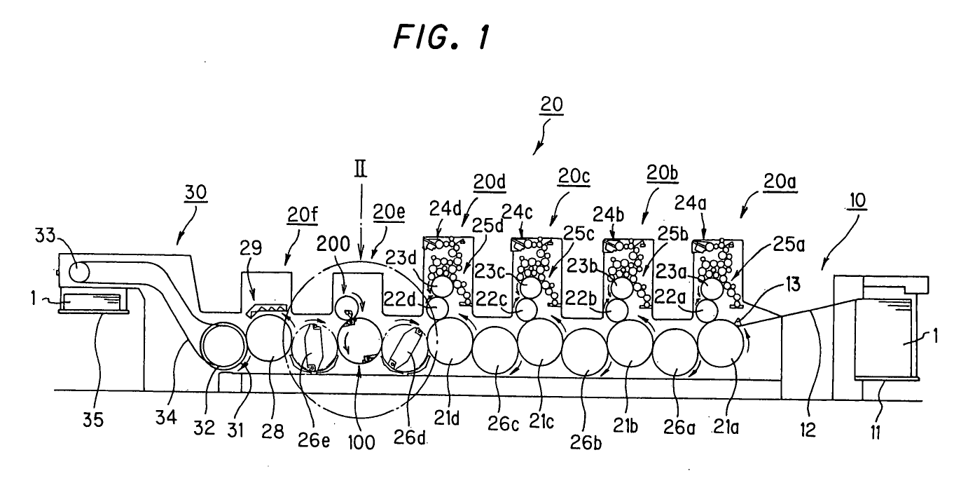

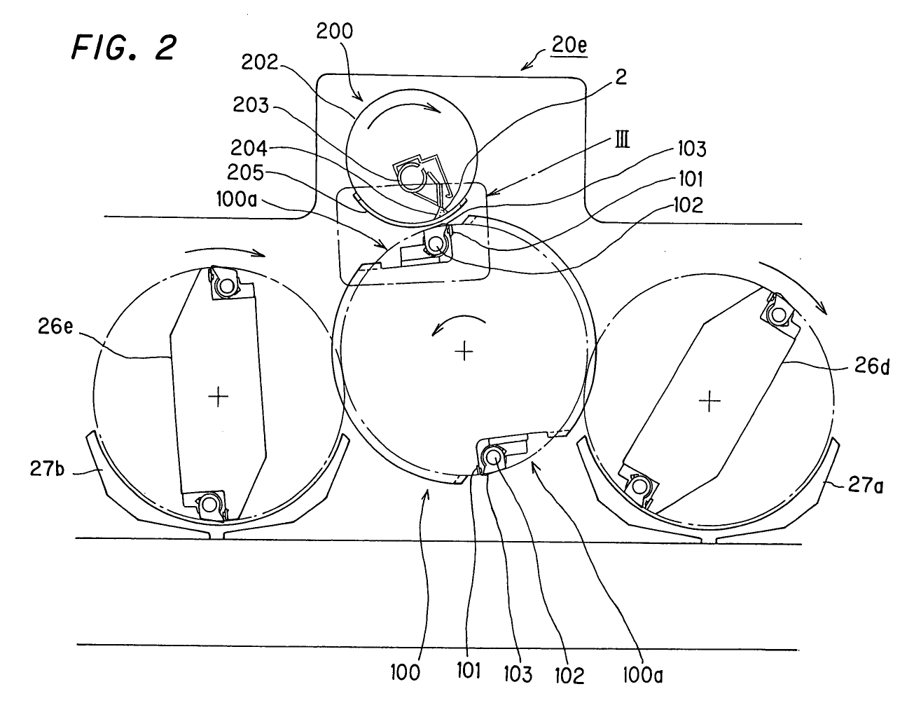

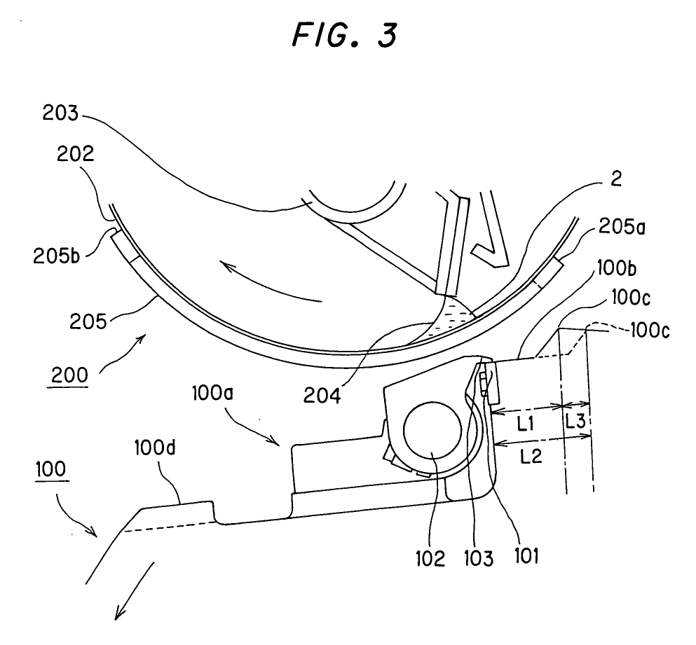

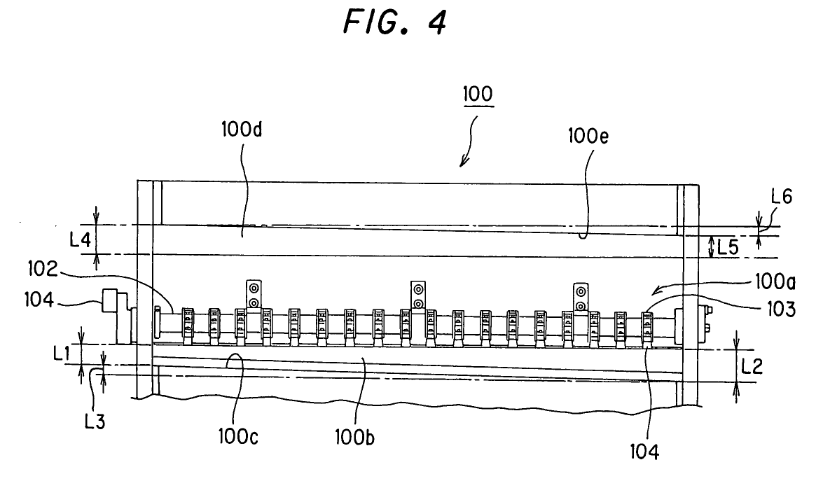

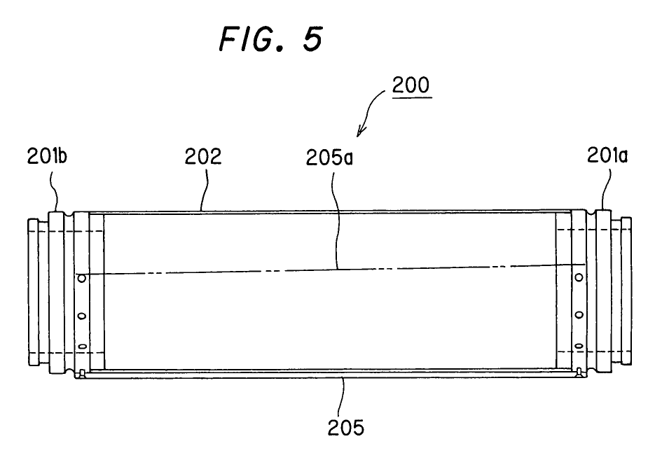

A printing press including a screen printing unit applying a liquid supply apparatus according to a first embodiment of the present invention will be described with reference to FIG. 1 to FIG. 10. FIG. 1 is an overall schematic block diagram of a printing press, FIG. 2 is an extracted and enlarged view of a section indicated with an arrow II in FIG. 1, FIG. 3 is an extracted and enlarged view of a section indicated with an arrow III in FIG. 2, FIG. 4 is a plan view of an impression cylinder shown in FIG. 2, and FIG. 5 is a cross-sectional view of a substantial part of a rotary screen device shown in FIG. 2, which is taken along an axial direction.

As shown in FIG. 1, a feeder 10 includes a feeder table 11. The feeder 10 also includes a feeder board 12 for sending flat paper sheets 1, which are sheets on the feeder table 11, one-by-one to a printing unit 20. At a front end of the feeder board 12, a swing arm shaft pregripper 13 is disposed to pass the flat paper sheet 1 to an impression cylinder 21a of a first offset printing unit 20a of the printing unit 20.

A blanket cylinder 22a is connected to the impression cylinder 21a of the first offset printing unit 20a of the printing unit 20 on a downstream side of the swing arm shaft pregripper 13 in a rotational direction. A plate cylinder 23a is connected to the blanket cylinder 22a on an upstream side of the impression cylinder 21a in a rotational direction. An ink supply device 24a is provided in a position on the plate cylinder 23a on an upstream side of the blanket cylinder 22a in a rotational direction. A dampening unit 25a is in a position on the plate cylinder 23a on an upstream side of the ink supply device 24a of in a rotational direction.

An impression cylinder 21b of a second offset printing unit 20b is connected through a transfer cylinder 26a to the impression cylinder 21a of the first offset printing unit 20a on a downstream side of the blanket cylinder 22a in a rotational direction. This second offset printing unit 20b includes a blanket cylinder 22b, a plate cylinder 23b, an ink supply device 24b, a dampening unit 25b, and the like which are arranged as similar to the first offset printing unit 20a.

Meanwhile, an impression cylinder 21c of a third offset printing unit 20c is connected through a transfer cylinder 26b to the impression cylinder 21b of the second offset printing unit 20b on a downstream side of the blanket cylinder 22b in a rotational direction. This third offset printing unit 20c also includes a blanket cylinder 22c, a plate cylinder 23c, an ink supply device 24c, a dampening unit 25c, and the like which are arranged as similar to the first and second offset printing units 20a and 20b.

Moreover, an impression cylinder 21d of a fourth offset printing unit 20d is connected through a transfer cylinder 26c to the impression cylinder 21c of the third offset printing unit 20c on a downstream side of the blanket cylinder 22c in a rotational direction. This fourth offset printing unit 20d also includes a blanket cylinder 22d, a plate cylinder 23d, an ink supply device 24d, a dampening unit 25d, and the like which are arranged as similar to the first to third offset printing units 20a to 20c.

As shown in FIGS. 1 and 2, an impression cylinder 100 of a screen printing unit 20e serving as a liquid supply apparatus is connected through a transfer cylinder 26d, which is formed of a skeleton cylinder (a solid cylinder) including a guiding device 27a for guiding transport of the flat paper sheet 1 by ejecting air as disclosed in Japanese Unexamined Patent Publication No. 2004-099314, for example, to the impression cylinder 21d of the fourth offset printing unit 20d on a downstream side of the blanket cylinder 22d in a rotational direction. The impression cylinder 100 has a structure to be described below.

As shown in FIGS. 2 to 4, gaps 100a extending along a direction of a shaft center of the impression cylinder 100 are formed in multiple positions (two positions in this embodiment) on an outer peripheral surface of the impression cylinder 100 at an even interval along a circumferential direction of the impression cylinder 100. A step portion 10b positioned closer to the shaft center of the impression cylinder 100 than the outer peripheral surface of the impression cylinder 100 is formed on the gap 100a of the impression cylinder 100 on the upstream side in a rotational direction (one side in the circumferential direction which is on a right side in FIG. 3 and on a lower side in FIG. 4) along the direction of the shaft center of the impression cylinder 100. Multiple gripper pads 101 are provided at predetermined intervals on the step portion 10b of the impression cylinder 100 along the direction of the shaft center of the impression cylinder 100.

A gripper shaft 102 is arranged inside the gap 100a of the impression cylinder 100 so that it takes a longitudinal direction along the direction of the shaft center of the impression cylinder 100. The gripper shaft 102 is rotatably supported relative to the impression cylinder 100. Multiple grippers 103 are provided at a given pitch along an axial direction of the gripper shaft 102 with their tip ends located on the gripper pads 101.

That is, the impression cylinder 100 is configured to set identical distances between shaft centers and the gripper pads 101 in terms of the impression cylinders 21a to 21d, the transfer cylinders 26a to 26d, and moreover, a transfer cylinder 26e, a transport cylinder 28, and a delivery cylinder 31 to be described later. Further, the impression cylinder 100 is also configured to set a longer distance between each shaft center and each outer peripheral surface. In this way, the impression cylinder 100 is able to pass the flat paper sheet 1 to and from the transfer cylinders 26d and 26e without causing the gripper pads 101 and the grippers 103 to project from the outer peripheral surface.

A boundary 100c between the step portion 100b of the gap 100a and the outer peripheral surface of the impression cylinder 100 is inclined relative to the direction of the shaft center of the impression cylinder 100 so that a length L1 of the step portion 100b on one side in the direction of the shaft center (which is a front side of the drawing in terms of FIG. 3 or a left side in terms of FIG. 4) of the impression cylinder 100 becomes smaller than a length L2 of the step portion 100b on the other side in the direction of the shaft center (which is a back side of the drawing in terms of FIG. 3 or a right side in terms of FIG. 4). In other words, a length of the outer peripheral surface of the impression cylinder 100 close to the step portion 100b is set such that the one end in the direction of the shaft center of the boundary 100c on the impression cylinder 100 is positioned closer to the gripper shaft 102 by a length L3 than the other end thereof.

In the meantime, a step portion 100d positioned closer to the shaft center of the impression cylinder 100 than the outer peripheral surface of the impression cylinder 100 is formed at the gap 100a of the impression cylinder 100 on a downstream side in terms of the rotational direction (on the other side in the circumferential direction, which is a left side in FIG. 3 or an upper side in FIG. 4) of the impression cylinder 100 along the direction of the shaft center of the impression cylinder 100. A boundary 100e between the step portion 100d of the gap 100a and the outer peripheral surface of the impression cylinder 100 is inclined relative to the direction of the shaft center of the impression cylinder 100 so that a length L4 of the step portion 100d on the one side in the direction of the shaft center (which is the front side of the drawing in terms of FIG. 3 or the left side in terms of FIG. 4) of the impression cylinder 100 becomes greater than a length L5 of the step portion 100d on the other side in the direction of the shaft center (which is the back side of the drawing in terms of FIG. 3 or the right side in terms of FIG. 4). In other words, a length of the outer peripheral surface of the impression cylinder 100 close to the step portion 100d is set such that the other end in the direction of the shaft center of the boundary 100e on the impression cylinder 100 is positioned closer to the gripper shaft 102 by a length L6 than the one end thereof.

Here, reference numeral 104 in FIG. 4 denotes a cam follower for moving rotationally the gripper shaft 102. In this embodiment, the gripper pads 101, the gripper shaft 102, the grippers 103, and the like collectively constitute seat retaining means.

Moreover, as shown in FIGS. 1 to 3, a rotary screen device 200 is connected to the impression cylinder 100 of the screen printing unit 20e on a downstream side in terms of the rotational direction of the transfer cylinder 26d. The rotary screen device 200 has a structure to be described below.

As shown in FIGS. 2, 3, and 5, hollow cylindrical flanges 201a and 201b, which are supported rotatably, support ends of a screen 202 that is a thin cylindrical plate material having small holes etched in accordance with an image. Inside the screen 202, there are an ink fountain 203 for storing special ink 2, and a squeegee 204 for supplying the special ink 2 inside the ink fountain 203 from the small holes on the screen 202 to the impression cylinder 100.

The flanges 201a and 201b are provided with a guard 205 which is a guide member configured to be positioned between the gap 100a of the impression cylinder 100 and the screen 202 when opposed to the gap 100a and to movably support the squeegee 204 through the screen 202. The guard 205 is formed into an arc shape including an inner peripheral surface having substantially the same curvature as curvature of an outer peripheral surface of the screen 202.

Moreover, the guard 205 is designed to enter the gap 100a of the impression cylinder 100 without contacting the outer peripheral surface of the impression cylinder 100, the grippers 103, and the like while the impression cylinder 100 and the screen 202 are rotating being contacted with each other, and to give a clearance having a length smaller than the length L3 between an end portion 205a on an upstream side in the rotational direction and an end portion on the upstream side in terms of the rotational direction (the boundary 100c) of the gap 10a of the impression cylinder 100 when these ends oppose each other. Meanwhile, the guard 205 is also designed to give a clearance having a length greater than the length L6 between an end portion 205b on a downstream side in the rotational direction and an end portion on the downstream side in a rotational direction (the boundary 100e) of the gap 100a of the impression cylinder 100 when these ends oppose each other. To achieve the foregoing configurations, a position of the guard 205 relative to the screen 202, as well as a length in the circumferential direction and shapes of the end portions 205a and 205b (such as angles of inclination relative to a direction of a shaft center of the screen 202), and the like are set appropriately in response to the shapes of the gap 100a, the boundaries 100c and 100e, and other factors of the impression cylinder 100.

Moreover, the rotary screen device 200 includes an unillustrated register adjusting device. By use of the register adjusting device, the rotary screen device 200 can adjust registers in a cocking direction, a circumferential direction, a lateral direction, and the like of the screen 202 in a range not exceeding the size of the clearances.

As shown in FIG. 1, the transfer cylinder 26e formed of a skeleton cylinder (a solid cylinder) including a guiding device 27b for guiding transport of the flat paper sheet 1 by ejecting air as disclosed in Japanese Unexamined Patent Publication No. 2004-099314, for example, is connected to the impression cylinder 100 of the screen printing unit 20e on the downstream side in a rotational direction of the rotary screen device 200. A transport cylinder 28 of a drying unit 20f is connected to the transfer cylinder 26e on the downstream side in a rotational direction of the impression cylinder 100. A drying lamp 29 for irradiating ultraviolet (UV) rays is provided on the transport cylinder 28 on the downstream side in a rotational direction of the transfer layer 26e.

A delivery cylinder 31 of a delivery unit 30 is connected to the transfer cylinder 28 of the drying unit 20f on a downstream side in a rotational direction of the drying lamp 29. The delivery cylinder 31 includes a sprocket 32 which is rotatable coaxially and integrally with the delivery cylinder 31. Moreover, the delivery unit 30 includes a delivery table 35. A sprocket 33 is placed above the delivery table 35. A delivery chain 34 including multiple unillustrated delivery grippers arranged at a given pitch is put on the sprockets 32 and 33.

Operations of the printing press having the above-described configuration according to this embodiment will now be described below.

Each flat paper sheet 1 individually sent out from the feeder table 11 of the feeder 10 onto the feeder board 12 is passed to the impression cylinder 21a of the first offset printing unit 20a of the printing unit 20 by use of the swing arm shaft pregripper 13. In the meantime, ink and dampening water are respectively supplied from the ink supply device 24a and the dampening unit 25a of the first offset printing unit 20a to the plate cylinder 23a, and then from the plate cylinder 23a to the blanket cylinder 22a. Thereafter, the ink is transferred from the blanket cylinder 22a to the flat paper sheet 1, and the flat paper sheet 1 is thereby subjected to printing in a first color. Then, the flat paper sheet 1 is passed to the impression cylinder 21b of the second offset printing unit 20b through the transfer cylinder 26a, and is subjected to printing in a second color by the second offset printing unit 20b in a similar manner to the first offset printing unit 20a. Thereafter, the flat sheet paper 1 is subjected to printing in third and fourth colors by the third and fourth offset printing units 20c and 20d similarly.

Then, the flat paper sheet 1 is subjected to gripping change to the gripper pads 101 and the grippers 103 of the impression cylinder 100 of the screen printing unit 20e through the transfer cylinder 26d. In the rotary screen device 200 of the screen printing unit 20e, the screen 202 is rotated along with rotation of the impression cylinder 100 and the special ink 2 inside the ink fountain 203 is pushed out of the small holes on the screen 202 by the squeegee 204 and is thereby supplied to perform thick printing of the special ink 2 corresponding to the small holes of the screen 202. Thereafter, the flat paper sheet 1 is passed from the impression cylinder 100 to the transport cylinder 28 of the drying unit 20f through the transfer cylinder 26e, and the printed ink is dried by UV irradiation from the drying lamp 29. Then, the flat paper sheet 1 is passed to the delivery cylinder 31 of the delivery unit 30, then transported by the delivery grippers in accordance with a traveling motion of the delivery chain 34, and then delivered onto the delivery table 35.

Thus, in the course of printing the flat sheet paper as described above, the screen 202 and the squeegee 204 of the rotary screen device 200 do not fall into the gap 100a of the impression cylinder 100 because in the screen printing unit 20a mounted is the guard 205 which movably supports the squeegee 204 through the screen 202 and which is located between the gap 100a and the screen 202 when the rotary screen 200 opposes to the gap 100a of the impression cylinder 100.

Moreover, in terms of the impression cylinder 100, the boundaries 100c and 100e between the step portions 100b and 100d of the gap 101a and the outer peripheral surface are inclined relative to the direction of the shaft center as described previously. Further, in terms of the rotary screen device 200, the length in the circumferential direction of the guard 205, the shapes of the end portions 205a and 205b (such as the angles of inclination relative to the direction of the shaft center of the screen 202), and the like are set in response to the shapes of the gap 111a and the boundaries 100c and 100e of the impression cylinder 100. Accordingly, it is possible to movably support the squeegee 204 oriented along the direction of the shaft center temporarily by use of both of the outer peripheral surface of the impression cylinder 100 and the guard 205 at the same time. In this way, it is possible to ensure prevention of even slight falling that is apt to occur when the squeegee 204 on the outer peripheral surface of the impression cylinder 100 moves onto the guard 205 or when the squeegee 204 on the guard 205 moves onto the outer peripheral surface of the impression cylinder 100.

For this reason, in the printing press applying the liquid supply device according to this embodiment, it is possible by the simple structure to prevent clashes between the grippers 102 and the rotary screen device 200 or falling of the screen 202 or the squeegee 204 into the gap 100a without causing any vibration of the impression cylinder 100 of the screen printing unit 20e even at the time of high-speed printing.

Therefore, according to the printing press applying the liquid supply device of this embodiment, it is possible to print the special ink 2 from the small holes on the screen 202 of the rotary screen device 200 onto the flat paper sheet 1 retained on the impression cylinder 100 of the screen printing unit 20e favorably and at low costs even at the time of high-speed printing.

Moreover, the length in the circumferential direction of the guard 205, the shapes of the end portions 205a and 205b, and the like are set so as to give the clearance between the end portion 205a of the guard 205 of the rotary screen device 200 located on the upstream side in a rotational direction and the end portion (the boundary 100c) of the gap 100a of the impression cylinder 100 on the upstream side in a rotational direction having the smaller length than the length L3 when these end portions oppose each other, and to give the clearance between the end portion 205b of the guard 205 of the rotary screen device 200 located on the downstream side in terms of the rotational direction and the end portion (the boundary 100e) of the gap 100a of the impression cylinder 100 on the upstream side in a rotational direction having the smaller length than the length L6 when these end portions oppose each other. Therefore, the guard 205 does not become an obstacle when performing register adjustment of the rotary screen device 200 in the above-described register adjustment positions. Accordingly, it is possible to perform register adjustment of the rotary screen device 200 without any problems.

### Other Embodiments

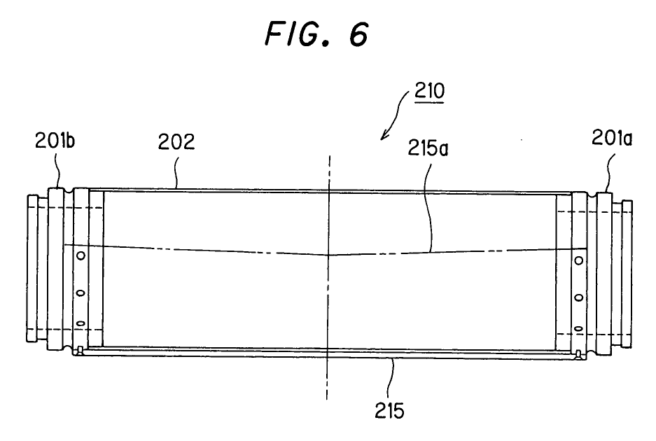

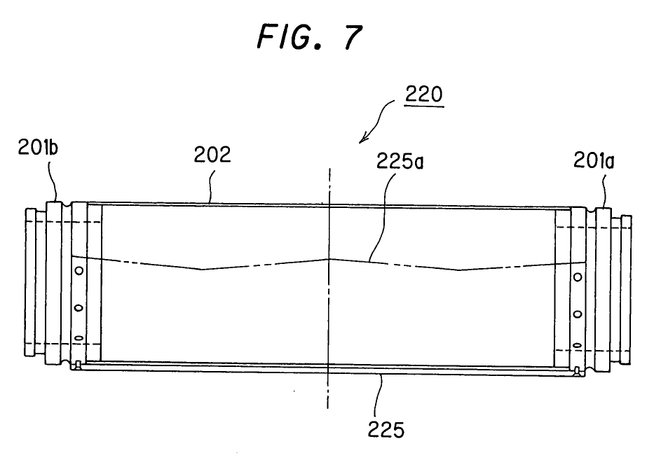

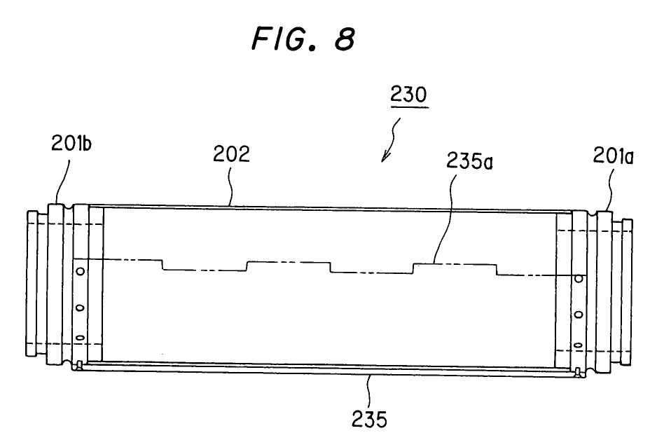

As shown in FIGS. 3 to 5, in the first embodiment, the boundaries 100c and 100e between the step portions 100b and 100d, and, the outer peripheral surface of the gap 101a of the impression cylinder 100 are set to incline straight to the direction of the shaft center while the end portions 205a and 205b of the guard 205 of the rotary screen device 200 are set to incline straight to the direction of the shaft center of the screen 202 so as to correspond to the shapes of the gap 10la and the boundaries 100c and 100e of the impression cylinder, so the squeegee 204 oriented along the direction of the shaft center is once movably supported by both of the outer peripheral surface of the impression cylinder and the guard 205 simultaneously. However, in another embodiment, it is also possible to apply a rotary screen device 210 including a guard 215 having an end portion 215a formed substantially into a V-shape as shown in FIG. 6, for example, in a way that the length in the circumferential direction will decrease as a point approaches the center of in the direction toward the shaft center of the screen 202. Here, in response to the shape of the end portion 215a of the guard 215 of the rotary screen device 210, a gap and boundaries of the impression cylinder are also formed substantially into a V-shape in a way that the length in the circumferential direction will increase as a point approaches the center in terms of the shaft center direction. In addition, in another embodiment, it is also possible to apply a rotary screen device 220 including a guard 225 having an end portion 225a formed substantially into a W-shape as shown in FIG. 7, for example, in a way that the length in the circumferential direction gradually decreases as a point separates from the center and the both ends in the direction of the shaft center of the screen 202. Here, in response to the shape of the end portion 225a of the guard 225 of the rotary screen device 220, a gap and boundaries of the impression cylinder are also formed substantially into a W-shape in a way that the length in the circumferential direction of the outer peripheral of the impression cylinder increases as a point separates from the center and the both ends in the direction of the shaft center. Furthermore, in another embodiment, it is also possible to apply a rotary screen device 230 such that the end portion 235a of the guard 235 is formed in a patterned concavo-convex shape as shown in FIG. 8, for example in a way that the length in the circumferential direction will decrease at every predetermined pitch along the direction of the shaft center of the screen 202. This enables once movably supporting the squeegee 204 oriented along the direction of the shaft center by use of the outer peripheral surface of the impression cylinder and the guard 215, 225 or 235 simultaneously by forming the gap and the boundaries of the impression cylinder in response to the shape of the end portion 235a of the guard 235 in the rotary screen 230 into a patterned concavo-convex shape in a manner that the length in the circumferential direction of the outer peripheral of the impression cylinder will increase at every predetermined pitch along the direction of the shaft center. Still in another embodiment, it is also possible to apply a rotary screen device including a guard having an end portion formed into a wave shape so as to gradually change the length in the circumferential direction at a given cycle along the direction of the shaft center of the screen. Here, in response to the shape of the end portion of the guard of the rotary screen device, a gap and boundaries of the impression cylinder are also formed substantially into a wave shape so as to gradually change the length in the circumferential direction of the outer peripheral of the impression cylinder at a given cycle along the direction along the direction of the shaft center. In this way, it is also possible to once movably support the squeegee 204 oriented along the direction of the shaft center by use of the outer peripheral surface of the impression cylinder and the guard 215, 225 or 235 simultaneously.

Meanwhile, the gripper pads 101, the gripper shaft 102, the grippers 103, and the like collectively constitute the sheet holding means in the first embodiment. In another embodiment, it is also possible to construct the sheet holding means by use of a suction retainer placed at a gap on an outer peripheral surface of an impression cylinder and provided with a suction port on a surface thereof as disclosed for an instance in Japanese Unexamined Patent Publication No. 2001-225445, suction means to be connected to this suction retainer, and suction retaining means including a switching means provided between the suction retainer and the suction means for opening a space between the suction retainer and the suction means when receiving a sheet and for shutting off the space between the suction retainer and the suction means when passing the sheet.

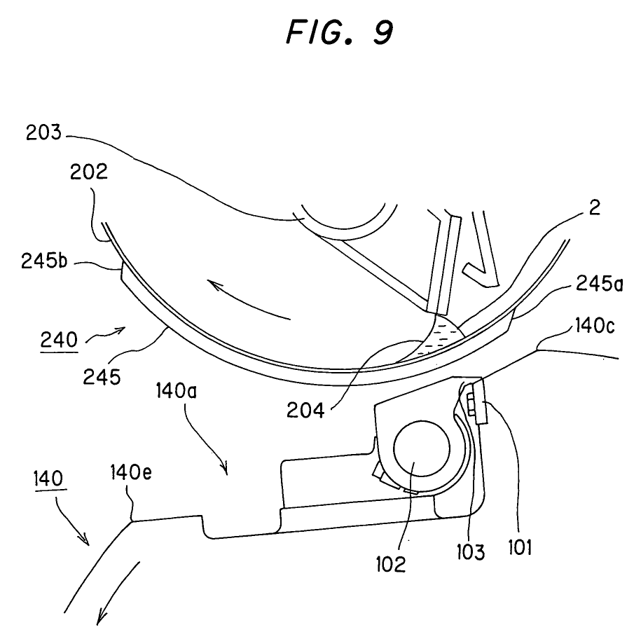

Moreover, in the first embodiment, the length in the circumferential direction, the shapes of the end portions 205a and 205b, and the like of the guard 205 are set so as to define the clearance having the length smaller than the length L3 between the end portion 205a of the guard 205 on the upstream side in the rotational direction and the end portion of the gap 100a of the impression cylinder 100 on the upstream side in a rotational direction (the boundary 100c) when these ends oppose each other, and to define the clearance having the length greater than the length L6 between the end portion 205b of the guard 205 on the downstream side in the rotational direction and the end portion of the gap 100a of the impression cylinder 100 on the downstream side in terms of the rotational direction (the boundary 100e) when these ends oppose each other. In this way, the present invention enables the rotary screen device 200 to execute register adjustment without any problems. However, when the rotary screen device is not particularly required to execute register adjustment, as shown in FIG. 9, an end portion 245a of a guard 245 of a rotary screen device 240 on an upstream side in a rotational direction may contact an end portion of a gap 140a of an impression cylinder 140 on an upstream side in a rotational direction (a boundary 140c) without providing a clearance when these end portions oppose each other. Moreover, in order that an end portion 245b of the guard 245 of the rotary screen device 240 on a downstream side in a rotational direction may contact an end portion on a downstream side in a rotational direction (a boundary 140d) of the gap 140a of the impression cylinder 140 without providing a clearance when these end portions oppose each other, a length in the circumferential direction of the guard 245, shapes of the end portions 245a and 245b, and other factors can also be up appropriately.

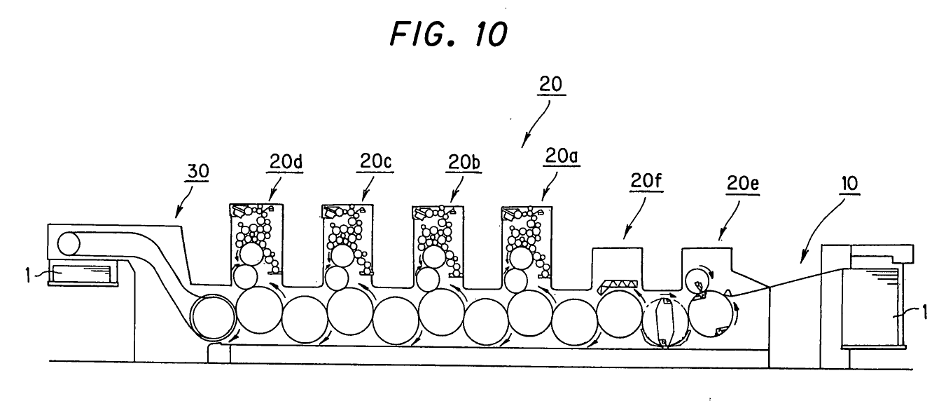

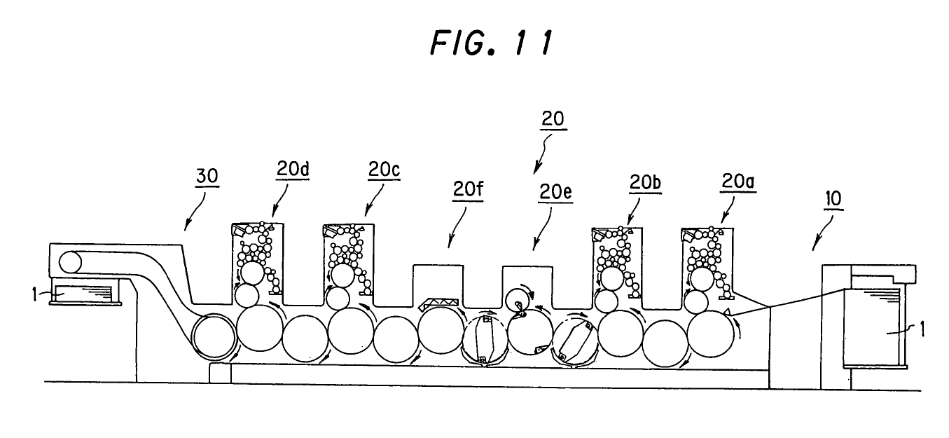

Meanwhile, in the first embodiment, the screen printing unit 20e and the drying unit 20f are disposed on the downstream side of the first to fourth offset printing units 20a to 20d. Instead, it is also possible to dispose the screen printing unit 20e and the drying unit 20f on the upstream side of the first to fourth offset printing units 20a to 20d as shown in FIG. 10, for example. Alternatively, it is also possible to dispose the screen printing unit 20e and the drying unit 20f between the pair of the first and second offset printing unit 20a and 20b and the pair of the third and fourth offset printing units 20c and 20d as shown in FIG. 11, for example.

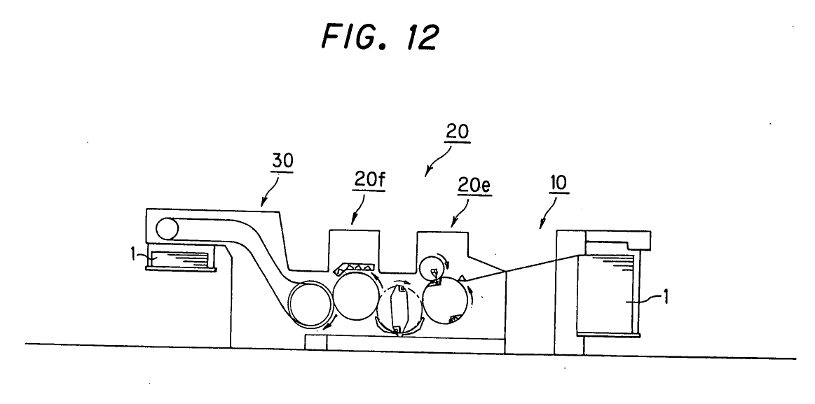

Moreover, the first embodiment describes the case of applying the present invention to the printing press that combines the offset printing units 20a to 20d and the screen printing unit 20e. Instead, it is also possible to apply the present invention to a screen printing press including the feeder 10, the screen printing unit 20e, the drying unit 20f, and the delivery unit 30 without containing any offset printing units as shown in FIG. 12, for example. Alternatively, it is also possible to combine the present invention and an assembly unit such as a rotation punching machine, which is different from a printing unit.

Meanwhile, the first embodiment describes the case of applying the present invention to the screen printing unit 20e configured to store the special ink inside the screen 202 of the rotary screen device 200 and to perform thick printing of the special ink 2 from the small holes on the screen 202 onto the flat paper sheet 1 by use of the squeegee 204. However, the present invention is not limited only to the foregoing configuration. For example, the present invention can be also utilized as a coating device configured to put varnish inside a screen of a rotary screen device and to perform coating of the varnish from small holes on the screen onto a flat paper sheet by use of a squeegee. As shown in this example, the present invention is applicable to a case of supplying a liquid from holes on a plate material of a rotary screen device to a sheet retained on an impression cylinder by use of a squeegee, as is similar to the above-described first embodiment.

According to the liquid supply apparatus of the present invention, it is possible to supply a liquid from holes on a plate material on a rotary screen device to a sheet retained on an impression cylinder by use of a squeegee favorably and even at a high speed.

A liquid supply apparatus according to the present invention is capable of supplying a liquid from holes on a plate material on a rotary screen device to a sheet retained on an impression cylinder by use of a squeegee favorably and at low costs even at a high speed. Therefore, by applying the liquid supply apparatus of the present invention to a screen printing unit of a printing press, it is possible to perform printing of special ink or the like from small holes on a screen on a rotary screen device to a flat paper sheet retained on an impression cylinder by use of a squeegee favorably and at low costs even at a high speed. This technique is extremely advantageous in the printing industry and the like.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A liquid supply apparatus, comprising:
a rotatably supported impression cylinder having a gap formed on an outer peripheral surface;
sheet holding means located inside the gap of the impression cylinder for holding the sheet; and
a rotary screen device including a rotatably supported hollow cylinder, a cylindrical plate material supported by the hollow cylinder so as to oppose the impression cylinder and provided with a hole on a peripheral surface, and a squeegee located inside the plate material so as to abut on an inner peripheral surface of the plate material and configured to supply a liquid stored inside the plate material from the hole of the plate material toward the impression cylinder,
wherein the rotary screen device comprises a guide member configured to be positioned between the gap and the plate material when opposed to the gap of the impression cylinder and to movably support the squeegee through the plate material.

2. The liquid supply apparatus according to claim 1,
wherein the guide member is formed into an arc shape including an inner peripheral surface having substantially the same curvature as curvature of the outer peripheral surface of the plate material.

3. The liquid supply apparatus according to claim 1,
wherein the outer peripheral surface of the impression cylinder and the guide member are formed such that the squeegee is movably supported once by both of the outer peripheral surface of the impression cylinder and the guide member simultaneously.

4. The liquid supply apparatus according to claim 1,
wherein a size of the guide member is set such that a clearance is provided between an end portion of the guide member on a downstream side in a rotational direction and an end portion of the gap on a downstream side in a rotational direction when the end portions oppose each other, and that a clearance is provided between an end portion of the guide member on an upstream side in the rotational direction and an end portion of the gap on an upstream side in the rotational direction when the end portions oppose each other.

5. The liquid supply apparatus according to claim 1,
wherein the guide member is configured to enter the gap of the impression cylinder without causing interference with the sheet holding means when the guide member opposes the gap.

6. The liquid supply apparatus according to claim 4,
wherein the end portions of the gap of the impression cylinder and the end portions of the guide member are formed such that a size of the clearance in the rotational directions becomes substantially uniform throughout a length in a direction along a width direction of the impression cylinder.

7. The liquid supply apparatus according to claim 6,
wherein the end portions of the gap of the impression cylinder and the end portions of the guide member are formed such that the clearance is inclined in terms of an axial direction of the impression cylinder.

8. The liquid supply apparatus according to claim 6, wherein the end portions of the gap of the impression cylinder and the end portions of the guide member are formed such that the clearance meanders in terms of an axial direction of the impression cylinder.
